(19) United States
(12) Patent Application Publication
(10) Pub. No.: US 2026/0225881 A1
(43) Pub. Date: Aug. 6, 2026

(54) A ROOM-TEMPERATURE-SOLID METAL ALLOY FOR MAKING WATER-REACTIVE ALUMINUM COMPOSITIONS

(71) Applicant: FOUND ENERGY CO, Boston, MA (US)

(72) Inventors: Ariel Jackson, Medford, MA (US); Peter Godart, Cambridge, MA (US)

(21) Appl. No.: 19/149,257

(22) PCT Filed: Jan. 18, 2024
(86) PCT No.: PCT/US2024/012010

§ 371 Date: Jul. 18, 2025

Related U.S. Application Data
(60) Provisional application No. 63/480,643, filed on Jan. 19, 2023.

(51) Int. Cl. C01B 3/08; B01J 23/18

(52) U.S. Cl. CPC C01B 3/08; B01J 23/18; C01B 2203/0277; C01B 2203/1041

(57) ABSTRACT

Provided herein are water-reactive aluminum compositions comprising aluminum or an alloy thereof and an activating metal alloy (e.g., a non-eutectic activating metal alloy comprising bismuth, tin, indium, and gallium; or an activating metal alloy comprising bismuth, tin, and indium). Some water-reactive aluminum compositions provided herein contain no gallium. Also provided herein are methods of activating aluminum to provide water-reactive aluminum compositions. Further provided are fuel mixtures comprising the water-reactive aluminum compositions described herein and water-reactive aluminum compositions with increased gallium content; and methods of providing hydrogen and/or steam using the water-reactive aluminum compositions described herein.

### CROSS-REFERENCE TO RELATED APPLICATIONS

This application claims the benefit of, and priority to, U.S. Provisional Application Ser. No. 63/480,643, filed on Jan. 19, 2023, the contents of which are incorporated by reference herein in their entirety.

### BACKGROUND

Aluminum is a promising candidate for energy storage due to its high energy density, abundance, low cost, non-toxicity, non-volatility, and non-reactivity in storage. One method of extracting the energy from aluminum is to react the aluminum with water to form hydrogen and heat as described in Reaction 1 or Reaction 2.

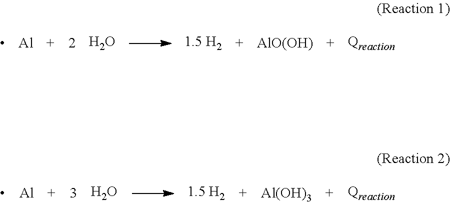

Untreated aluminum will typically not react with water due to the highly passivating oxide layer that forms on its surface. However, the oxide layer may be disrupted by an appropriate catalyst, thereby activating the aluminum to make it water-reactive.

Existing catalysts for this purpose are typically gallium or alloys where gallium is the primary constituent (>50% by mass). Because gallium is an expensive metal and abundance is limited, it is desirable to have catalysts with limited gallium content, 10% or less, including catalysts with no gallium.

### SUMMARY

In one aspect, provided herein is a water-reactive aluminum composition comprising:
aluminum or an alloy thereof having a surface oxide layer, an interior volume, and a microstructure; and
a non-eutectic activating metal alloy comprising bismuth, tin, indium, and gallium, wherein the non-eutectic activating metal alloy is disposed along the microstructure of the aluminum or the alloy thereof, and wherein the non-eutectic activating metal alloy is less than or equal to about 10% gallium by mass, and
   wherein when water is introduced to the composition, the aluminum or alloy thereof disintegrates to expose the interior volume to the water, and a rapid hydrolysis reaction occurs.

In another aspect, provided herein is a water-reactive aluminum composition comprising:
aluminum or an alloy thereof having a surface oxide layer, an interior volume, and a microstructure; and
an activating metal alloy comprising at least two metals selected from the group consisting of bismuth, tin, and indium, wherein the activating metal alloy is disposed along the microstructure of the aluminum or the alloy thereof,
wherein when water is introduced to the composition, the aluminum or alloy thereof disintegrates to expose the interior volume to the water, and a rapid hydrolysis reaction occurs,
wherein the water-reactive aluminum composition contains no gallium.

In another aspect, provided herein is a method of activating aluminum or an alloy thereof, the method comprising:
contacting the aluminum or alloy thereof with a non-eutectic activating metal alloy comprising bismuth, tin, indium, and gallium to provide a mixture; and
heating the mixture above the melting temperature of the non-eutectic activating metal alloy and below the melting temperature of the aluminum or alloy thereof for a predetermined period of time to provide a water-reactive aluminum composition.

In another aspect, provided herein is a method of activating aluminum or an alloy thereof, the method comprising:
contacting the aluminum or alloy thereof with an activating metal alloy comprising tin, indium, and gallium to provide a mixture; and
heating the mixture above the melting temperature of the non-eutectic activating metal alloy and below the melting temperature of the aluminum or alloy thereof for a predetermined period of time to provide a water-reactive aluminum composition.

In another aspect, provided herein is a method of activating aluminum or an alloy thereof, the method comprising:
contacting the aluminum or alloy thereof with an activating metal alloy comprising at least two metals selected from the group consisting of bismuth, tin, and indium to provide a mixture, wherein the mixture contains no gallium; and
heating the mixture above the melting temperature of the activating metal alloy for a predetermined period of time to provide a water-reactive aluminum composition.

In another aspect, provided herein is a method of providing hydrogen and/or steam, the method comprising contacting a water-reactive aluminum composition disclosed herein with water, wherein a rapid hydrolysis reaction occurs, thereby providing hydrogen and/or steam.

In another aspect, provided herein is a fuel mixture comprising a plurality of water-reactive aluminum compositions disclosed herein and a plurality of water-reactive aluminum compositions comprising aluminum and from 0 to about 3% or from about 3 to about 6% gallium by mass, wherein gallium is present in varying amounts in the plurality of compositions, and wherein the varying amounts of gallium achieves a distribution of reaction rates at a given reaction initiation temperature or steady-state operating temperature when the compositions are contacted with water.

### BRIEF DESCRIPTION OF THE DRAWINGS

FIG. 1 is a diagram showing a method for making the low melting point catalyst.

FIG. 2 is a schematic diagram showing a rotating drum as an example for the aluminum activation process.

FIG. 3 is an image showing the start of the reaction of aluminum, activated with the catalyst, just after exposure to water.

FIG. 4 is a set of images showing the vigorous nature of the reaction once underway, after some amount of time and/or temperature increase of the water.

FIG. 5 is a graph showing the hydrogen flow (g/hr) and feedstock usage overtime (%_{wt}) resulting from the reaction of aluminum (sourced from used beverage cans) activated with catalyst Sample C (comprising ~33% Sample C by mass).

FIG. 6 is a graph showing power (kW) as a function of energy resulting from the reaction of aluminum (sourced from used beverage cans) activated with catalyst Sample C (comprising ~33% Sample C by mass).

FIG. 7 is a graph showing power (kW) as a function of feedstock consumption (%_{wt}) resulting from the reaction of aluminum (sourced from used beverage cans) activated with catalyst Sample C (comprising ~33% Sample C by mass).

FIG. 8 is a graph showing the hydrogen flow (g/hr) and feedstock usage overtime (%_{wt}) resulting from the reaction of aluminum (sourced from used beverage cans) activated with catalyst Sample C (comprising ~50% Sample C by mass).

FIG. 9 is a graph showing power (kW) as a function of energy resulting from the reaction of aluminum (sourced from used beverage cans) activated with catalyst Sample C (comprising ~50% Sample C by mass).

FIG. 10 is a graph showing power (kW) as a function of feedstock consumption (% Wt) resulting from the reaction of aluminum (sourced from used beverage cans) activated with catalyst Sample C (comprising ~50% Sample C by mass).

FIG. 11 is a graph showing the hydrogen flow (g/hr) and feedstock usage overtime (%_{wt}) resulting from the reaction of aluminum (sourced from used beverage cans) activated with catalyst Sample C (comprising ~50% Sample C by mass).

FIG. 12 is a graph showing power (kW) as a function of energy resulting from the reaction of aluminum (sourced from used beverage cans) activated with catalyst Sample C (comprising ~50% Sample C by mass).

FIG. 13 is a graph showing power (kW) as a function of feedstock consumption (%_{wt}) resulting from the reaction of aluminum (sourced from used beverage cans) activated with catalyst Sample C (comprising ~50% Sample C by mass).

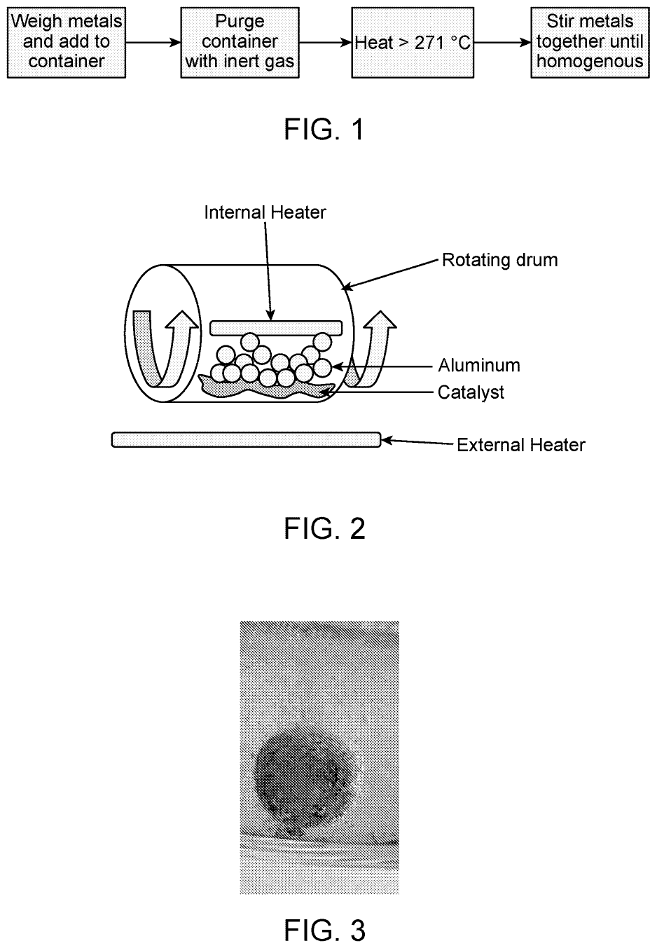

### DETAILED DESCRIPTION

The present disclosure provides, in part, new catalysts (e.g., activating metal alloys) for the purpose of activating aluminum and water-reactive aluminum compositions activated with catalyst compositions disclosed herein. In some embodiments, disclosed herein is an activating alloy comprising indium, bismuth, tin, and optionally gallium for the purpose of catalytically activating aluminum metal. A contemplated catalyst may make aluminum reactive with water or steam as described in Reaction 1 or Reaction 2. In some embodiments, the catalysts described herein have reduced gallium content (e.g, less than or equal to about 10% gallium by mass) while also having a low melting point (e.g., less than 200° C., or less than 157° C.).

Also provided herein is an activating alloy comprising indium, bismuth, tin, and a variable amount of gallium; where the amount of gallium is varied to alter the water reactivity (e.g., initiation temperature and/or reaction rate) of a water-reactive aluminum composition comprising the activating alloy.

Applications of the contemplated catalyst may include but are not limited to: aluminum-water reactors, H₂ generation, heat generation, steam generation, AlO(OH) production, Al(OH)₃ production, and aluminum embrittlement.

In one aspect, provided herein is a water-reactive aluminum composition comprising:
aluminum or an alloy thereof having a surface oxide layer, an interior volume, and a microstructure; and
a non-eutectic activating metal alloy comprising bismuth, tin, indium, and gallium, wherein the non-eutectic activating metal alloy is disposed along the microstructure of the aluminum or the alloy thereof,
wherein when water is introduced to the composition, the aluminum or alloy thereof disintegrates to expose the interior volume to the water, and a rapid hydrolysis reaction occurs.

In another aspect, provided herein is a water-reactive aluminum composition comprising:
aluminum or an alloy thereof having a surface oxide layer, an interior volume, and a microstructure; and
a non-eutectic activating metal alloy comprising bismuth, tin, indium, and gallium, wherein the non-eutectic activating metal alloy is disposed along the microstructure of the aluminum or the alloy thereof and wherein the non-eutectic activating metal alloy is less than or equal to about 10% gallium by mass, and
wherein when water is introduced to the composition, the aluminum or alloy thereof disintegrates to expose the interior volume to the water, and a rapid hydrolysis reaction occurs.

The term “non-eutectic”, as used herein, refers to an alloy where the melting point of the alloy is higher than the melting point of at least one of the constituent metals.

The term “microstructure” of aluminum, as used herein, refers to an arrangement of crystalline aluminum grains, intermetallic phases, and crystalline defects forming a larger aluminum particle or object, with grain boundaries at the interfaces between the individual aluminum grains.

In another aspect, provided herein is a water-reactive aluminum composition comprising:
aluminum or an alloy thereof having a surface oxide layer, an interior volume, and a microstructure; and
an activating metal alloy comprising bismuth, tin, and indium, wherein the activating metal alloy is disposed along the microstructure of the aluminum or the alloy thereof,
wherein when water is introduced to the composition, the aluminum or alloy thereof disintegrates to expose the interior volume to the water, and a rapid hydrolysis reaction occurs,
wherein the water-reactive aluminum composition contains no gallium.

In another aspect, provided herein is a water-reactive aluminum composition comprising:
aluminum or an alloy thereof having a surface oxide layer, an interior volume, and a microstructure; and
an activating metal alloy comprising at least two metals selected from the group consisting of bismuth, tin, and indium, wherein the activating metal alloy is disposed along the microstructure of the aluminum or the alloy thereof,
wherein when water is introduced to the composition, the aluminum or alloy thereof disintegrates to expose the interior volume to the water, and a rapid hydrolysis reaction occurs,
wherein the water-reactive aluminum composition contains no gallium.

In some embodiments, the activating metal alloy comprises bismuth, tin, and indium.

In some embodiments, the water-reactive aluminum composition is formed by a process comprising contacting the aluminum or alloy thereof with the activating metal alloy, wherein the activating metal alloy is in liquid form and the aluminum or alloy thereof is in solid form at the time the aluminum or alloy thereof is contacted with the activating metal alloy. In some embodiments, the activating metal alloy is heated at or above its melting point prior to contacting the aluminum or alloy thereof. In some embodiments, the activating metal alloy has a melting point below the melting temperature of the aluminum or alloy thereof.

In some embodiments, the activating metal alloy has a melting point of less than 200° C. In some embodiments, the activating metal alloy has a melting point of less than 157° C. In some embodiments, the activating metal alloy has a melting point of less than 150° C. In some embodiments, the activating metal alloy has a melting point of less than 100° C.

In some embodiments, the activating metal alloy is about 2% to about 20%, about 2% to about 18%, about 2% to about 16%, about 2% to about 14%, about 2% to about 12%, about 2% to about 10%, about 2% to about 8%, or about 2% to about 4% of the total mass of the water-reactive aluminum composition. In some embodiments, the activating metal alloy is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 30%, about 40%, or about 50% of the total mass of the water-reactive aluminum composition.

In some embodiments, the activating metal alloy is at least about 6% or about 6% of the total mass of the water-reactive aluminum composition.

In other embodiments, the aluminum or alloy thereof comprises one or more alloying elements selected from the group consisting of copper, silicon, iron, manganese, zinc, titanium, magnesium, lithium, cadmium, zirconium, beryllium, scandium, sodium, cerium, yttrium, silver, calcium, boron, chromium, bismuth, lead, vanadium, nickel, cobalt, oxygen, or gallium, the alloying elements having in total from 0 to about 20% of the total mass of the aluminum.

In some embodiments, the aluminum or alloy thereof does not comprise gallium, indium, bismuth, and/or tin as alloying elements. In some embodiments, the aluminum or alloy thereof consists essentially of aluminum. In some embodiments, the aluminum or alloy thereof consists of aluminum.

The term “about,” as used herein, means approximately, in the region of, roughly, or around. Unless otherwise stated for a numerical value noted, when the term “about” is used in conjunction with a numerical range, it modifies that range by extending the boundaries above and below the numerical values set forth. Unless otherwise stated for a numerical value noted, the term “about” is used herein to modify a numerical value above and below the stated value by a variance of 1%, 2% 3%, 4%, 5%, 6%, 7%, 8%, 9%, 10%, 15%, 20%, 25%, or 50%. For nonlimiting example, a range of “about 2 to about 20” can mean 1.98 to 22, or 1 to 30, or other ranges therebetween. Unless otherwise stated for a percentage range noted, when the term “about” is used in conjunction with a percentage range, it modifies that range by extending the boundaries above and below the percentages set forth, Unless otherwise stated for the percentage noted, the term “about” is used herein to modify a percentage above and below the stated percentage by 1%, 2%, 3%, 4%, 5%, 6%, 7%, 8%, 9%, 10%, 15%, 20%, 25%, or 50% (as an absolute, which may be limited to 0% as a minimum), or by a percentage of the stated percentage i.e. 1% 2%, 3%, 4%5%, 6%, 7%, 8%, 9%, 10%, 15%, 20%, 25%, or 50% of the percentage. For nonlimiting example, a range of “about 2% to about 20%” can mean 1% to 21%, or 0% to 70%, or other ranges therebetween, or 1.98% to 22%, or 1% to 30% (as a percentage of the percentage range). For nonlimiting example, a percentage value of “about 30%” can mean 29% to 31%, or 0% to 80%, or other ranges therebetween, or 27% to 33%, or 15% to 45% (as a percentage of the percentage value), or other ranges therebetween. Unless otherwise stated for a numerical range noted, numerical ranges recited herein by endpoints include all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about.”

In some embodiments, the activating metal alloy consists essentially of bismuth, gallium, indium, and tin. In some embodiments, the activating metal alloy consists of bismuth, gallium, indium, and tin. In some embodiments, the activating metal alloy consists essentially of bismuth, tin, and indium. In some embodiments, the activating metal alloy consists of bismuth, tin, and indium. In some embodiments, the activating metal consists essentially of gallium, tin, and indium. In some embodiments, the activating metal consists of gallium, tin, and indium.

In certain embodiments, the activating metal alloy comprises Field's Metal, comprising about 51% (e.g., about 51.2%) indium; about 32% (e.g., about 32.0%) bismuth; and about 17% (e.g., about 16.8%) tin by mass.

In some embodiments, the activating metal alloy comprises less than or equal to about 5% gallium by mass. In some embodiments, the activating metal alloy comprises less than or equal to about 10% gallium by mass. In some embodiments, the activating metal alloy comprises less than or equal to about 15% gallium by mass. In some embodiments, the activating metal alloy comprises less than or equal to about 20% gallium by mass. In some embodiments, the activating metal alloy comprises less than or equal to about 25% gallium by mass. In some embodiments, the activating metal alloy comprises less than or equal to about 30% gallium by mass.

In some embodiments, the activating metal alloy comprises less than about 10% gallium by mass.

In some embodiments, the activating metal alloy comprises about 1% gallium by mass. In some embodiments, the activating metal alloy comprises about 2% gallium by mass. In some embodiments, the activating metal alloy comprises about 3% gallium by mass. In some embodiments, the activating metal alloy comprises about 4% gallium by mass. In some embodiments, the activating metal alloy comprises about 5% gallium by mass. In some embodiments, the activating metal alloy comprises about 6% gallium by mass. In some embodiments, the activating metal alloy comprises about 7% gallium by mass. In some embodiments, the activating metal alloy comprises about 8% gallium by mass. In some embodiments, the activating metal alloy comprises about 9% gallium by mass. In some embodiments, the activating metal alloy comprises about 10% gallium by mass. In some embodiments, the activating metal alloy comprises about 15% gallium by mass. In some embodiments, the activating metal alloy comprises about 20% gallium by mass.

In some embodiments, the activating metal alloy may comprise from about 5 to about 10% gallium by mass, from about 1 to about 5% gallium by mass, from 0 to about 1% gallium by mass, or 0% gallium by mass.

In some embodiments, the activating metal alloy comprises about 30% indium by mass. In some embodiments, the activating metal alloy comprises about 35% indium by mass. In some embodiments, the activating metal alloy comprises about 40% indium by mass. In some embodiments, the activating metal alloy comprises about 45% indium by mass. In some embodiments, the activating metal alloy comprises about 50% indium by mass. In some embodiments, the activating metal alloy comprises about 55% indium by mass. In some embodiments, the activating metal alloy comprises about 60% indium by mass. In some embodiments, the activating metal alloy comprises about 65% indium by mass. In some embodiments, the activating metal alloy comprises about 70% indium by mass.

In some embodiments, the activating metal alloy may comprise from about 46 to about 48% indium by mass, from about 48 to about 50% indium by mass, from about 50 to about 51% indium by mass, or from about 51 to about 53% indium by mass.

In some embodiments, the activating metal alloy comprises about 10% bismuth by mass. In some embodiments, the activating metal alloy comprises about 15% bismuth by mass. In some embodiments, the activating metal alloy comprises about 20% bismuth by mass. In some embodiments, the activating metal alloy comprises about 25% bismuth by mass. In some embodiments, the activating metal alloy comprises about 30% bismuth by mass. In some embodiments, the activating metal alloy comprises about 35% bismuth by mass. In some embodiments, the activating metal alloy comprises about 40% bismuth by mass. In some embodiments, the activating metal alloy comprises about 45% bismuth by mass. In some embodiments, the activating metal alloy comprises about 50% bismuth by mass.

In some embodiments, the activating metal alloy may comprise from about 28 to about 30% bismuth by mass, from about 30 to about 31% bismuth by mass, from about 31 to about 32% bismuth by mass, or from about 32 to about 34% bismuth by mass.

In some embodiments, the activating metal alloy comprises about 5% tin by mass. In some embodiments, the activating metal alloy comprises about 10% tin by mass. In some embodiments, the activating metal alloy comprises about 15% tin by mass. In some embodiments, the activating metal alloy comprises about 20% tin by mass. In some embodiments, the activating metal alloy comprises about 25% tin by mass. In some embodiments, the activating metal alloy comprises about 30% tin by mass. In some embodiments, the activating metal alloy comprises about 35% tin by mass. In some embodiments, the activating metal alloy comprises about 40% tin by mass.

In some embodiments, the activating metal alloy may comprise from about 15 to about 16% tin by mass, 16-16.5% tin by mass, 16.5-16.8% tin by mass, or 16.8-18% tin by mass.

In one embodiment, the activating metal alloy comprises about 6% gallium, about 48% indium, about 30% bismuth, and about 16% tin.

In some embodiments, the activating metal alloy comprises bismuth, tin, and indium in amounts sufficient to reduce the melting point of the activating metal alloy below 200° C. when the activating metal alloy comprises less than or equal to 10% gallium by mass.

In some embodiments, the activating metal alloy does not comprise cadmium and/or lead.

In other embodiments, the activating metal alloy is solid at room temperature (e.g., at 20° C.).

The term “room temperature” as used herein refers to 20° C.

In certain embodiments, the activating metal alloy is liquid below the melting point of indium (about 157° C.).

In another aspect, the present disclosure provides a method of activating aluminum or an alloy thereof, the method comprising:
contacting the aluminum or alloy thereof with a non-eutectic activating metal alloy comprising bismuth, tin, indium, and gallium to provide a mixture; and
heating the mixture above the melting temperature of the non-eutectic activating metal alloy for a predetermined period of time to provide a water-reactive aluminum composition.

In another aspect, the present disclosure provides a method of activating aluminum or an alloy thereof, the method comprising:
contacting the aluminum or alloy thereof with a non-eutectic activating metal alloy comprising bismuth, tin, indium, and gallium to provide a mixture; and
heating the mixture above the melting temperature of the non-eutectic activating metal alloy and below the melting temperature of the aluminum or alloy thereof for a predetermined period of time to provide a water-reactive aluminum composition.

In another aspect, the present disclosure provides a method of activating aluminum or an alloy thereof, the method comprising:
contacting the aluminum or alloy thereof with an activating metal alloy comprising bismuth, tin, and indium to provide a mixture, wherein the mixture contains no gallium; and
heating the mixture above the melting temperature of the activating metal alloy for a predetermined period of time to provide a water-reactive aluminum composition.

In another aspect, the present disclosure provides a method of activating aluminum or an alloy thereof, the method comprising:
contacting the aluminum or alloy thereof with an activating metal alloy comprising at least two metals selected from the group consisting of bismuth, tin, and indium to provide a mixture, wherein the mixture contains no gallium; and
heating the mixture above the melting temperature of the activating metal alloy and below the melting temperature of the aluminum or alloy thereof for a predetermined period of time to provide a water-reactive aluminum composition.

In some embodiments, the activating metal alloy comprises bismuth, tin, and indium.

In another aspect, the present disclosure provides a method of activating aluminum or an alloy thereof, the method comprising:
contacting the aluminum or alloy thereof with an activating metal alloy comprising tin, indium, and gallium to provide a mixture; and
heating the mixture above the melting temperature of the non-eutectic activating metal alloy and below the melting temperature of the aluminum or alloy thereof for a predetermined period of time to provide a water-reactive aluminum composition.

In some embodiments, the non-eutectic activating metal alloy does not comprise bismuth.

In some embodiments, the activating metal alloy comprises bismuth, tin, and indium.

In some embodiments, the activating metal alloy is an activating metal alloy described herein.

In some embodiments, contacting the aluminum or alloy thereof with the activating metal alloy comprises melting the activating metal alloy and applying the activating metal alloy evenly to the surface of the aluminum or alloy thereof.

In some embodiments, the mixture comprises the activating metal alloy in an amount of about 10% to about 10%, about 10% to about 20%, about 20% to about 50%, about 50% to about 100%, about 100% to about 300%, or about 300% to about 600% of the mass of the aluminum or alloy thereof. In some embodiments, the mixture comprises the activating metal alloy in an amount of about 0% to about 3%, about 3% to about 6%, about 6% to about 10%, about 10% to about 100%, or about 100% to about 700% of the mass of the aluminum or alloy thereof. In some embodiments, the mixture comprises the activating metal alloy in an amount of about 5% of the mass of the aluminum or alloy thereof. In some embodiments, the mixture comprises the activating metal alloy in an amount of about 10% of the mass of the aluminum or alloy thereof. In some embodiments, the mixture comprises the activating metal alloy in an amount of about 20% of the mass of the aluminum or alloy thereof. In some embodiments, the mixture comprises the activating metal alloy in an amount of about 30% of the mass of the aluminum or alloy thereof. In some embodiments, the mixture comprises the activating metal alloy in an amount of about 40% of the mass of the aluminum or alloy thereof.

In some embodiments, the predetermined period of time is about 1 hour to about 3 hours. In some embodiments, the predetermined period of time is about 1 hour, about 2 hours, about 3 hours, about 4 hours, about 5 hours, about 6 hours, about 7 hours, about 8 hours, about 9 hours, about 10 hours, about 15 hours, about 20 hours, about 30 hours, about 2 days, about 3 days, about 4 days, about 5 days, about 6 days, about 7 days, about 8 days, about 9 days, or about 10 days.

In certain embodiments, the method further comprises varying the amount of gallium in the activating metal alloy such that the temperature required for the water-reactive aluminum composition to react with water is altered.

In other embodiments, the method further comprises varying the amount of gallium in the activating metal alloy such that the temperature at which the rate of reaction of the water-reactive aluminum composition with water accelerates to form steam upon contact of the water-reactive aluminum composition with water is altered.

In some embodiments, the method further comprises varying the amount of gallium in the activating metal alloy such that hydrogen gas is produced in the absence of steam upon contact of the water-reactive aluminum composition with water.

In certain embodiments, the method further comprises continuously agitating the mixture of the aluminum or alloy thereof and activating metal alloy in a rotating drum while heating the mixture above the melting point of the activating metal alloy.

In some embodiments, the mixture is heated to a temperature of 60° C. to 100° C., 100° C. to 150° C., 150° C. to 200° C., or 200° C. to 250° C.

In other embodiments, the mixture is heated with a heating element that is internal to the rotating drum.

In some embodiments, the mixture is heated with a heating element that is external to the rotating drum.

Also provided herein is a method of providing hydrogen and/or steam, the method comprising contacting a water-reactive aluminum composition disclosed herein with water, wherein a rapid hydrolysis reaction occurs, thereby providing hydrogen and/or steam.

In some embodiments, the method further comprises recovering at least about 50%, at least about 60%, at least about 70%, at least about 80%, at least about 90%, at least about 95%, at least about 99%, at least about 99.9%, or at least about 99.99% of the activating metal alloy after the rapid hydrolysis reaction occurs. In certain embodiments, the method further comprises recovering at least about 95% of the activating metal alloy after the rapid hydrolysis reaction occurs.

Provided herein, in part, is a fuel mixture comprising a plurality of water-reactive aluminum compositions described herein and a plurality of water-reactive aluminum compositions comprising aluminum and from 0 to about 3% or from about 3 to about 6% gallium by mass, wherein gallium is present in varying amounts in the plurality of compositions, and wherein the varying amounts of gallium achieves a distribution of reaction rates at a given reaction initiation temperature or steady-state operating temperature when the compositions are contacted with water.

### EXAMPLES

### Example 1: Preparation of Activating Metal Alloy Catalysts and Use Thereof in Activation of Aluminum

The activating metal alloy was prepared by first mixing the appropriate amounts of indium, bismuth, tin, and/or gallium in a container suitable for heating such as glass, steel, or another material. Aluminum containers were not used due to reactivity with the alloy. As used in the examples, the term “catalyst” refers to an activating metal alloy (e.g., Samples A-F).

In the experiments described below, power output, energy output, and yield were calculated by measuring the flow of hydrogen released during the reaction. Energy released as hydrogen from the reaction of aluminum with water was extrapolated from the hydrogen flow using the known higher heating value (HHV) combustion energy of hydrogen. Energy released as heat/steam from the reaction of aluminum with water was extrapolated from the hydrogen flow using the fixed ratio of hydrogen (51.2%) and heat (48.8%) released during the reaction of aluminum with water (see Reaction 1 and Reaction 2).

Exemplary compositions of the activating metal alloy are shown in Table 1.

TABLE 1
Activating metal alloy compositions

| | Ga % by | In % by | Bi % by | Sn % by |
|---|---|---|---|---|
| Sample | mass | mass | mass | mass |
| A | 0 | 51.2 | 32.0 | 16.8 |
| B | 1 | 50.7 | 31.7 | 16.6 |
| C | 5 | 48.6 | 30.4 | 16.0 |
| D | 6 | 48 | 30 | 16 |
| E | 10 | 46.1 | 28.8 | 15.1 |
| F | 68.5 | 21.5 | 0 | 10.0 |

### Preparation of Samples A, D, and E

The metals were heated in a container to above the highest melting point of the group, which is bismuth at 271° C. In this example, a hotplate set to 500° C. was used; however, other heating methods such as an oven, furnace, or gas torch may also be used. To protect the metals from oxidation, the container was filled with argon during heating. Any inert gas, such as nitrogen, helium, neon, xenon, etc. may also be used. When an inert gas is not used, the bismuth in particular may discolor, forming a yellowish-brown surface layer. Once the indium metal has melted, the tin, bismuth, and gallium were stirred together to form the homogenous liquid metal alloy. Upon cooling to room temperature, the catalyst had solidified.

Samples B and C may be prepared using methods substantially the same as those described above.

Preparation of Activated Aluminum Using Sample D and Reaction with Water

To activate aluminum with Sample D, 4 g of Sample D was heated above its melting point of approximately 60° C. A hotplate set to 200° C. was used to melt the catalyst; however, another form of heating may also be used. The catalyst and 0.6 g aluminum were placed in a sealed container, with an excess of catalyst used for this example where the catalyst amount was 650% the mass of the aluminum. Aluminum may also be activated by other ratios of catalyst mass from 0 to about 3%, from 3 to about 6%, from about 6 to about 10%, from about 10 to about 100%, and from about 100 to about 700% of the aluminum mass being activated. The container was agitated by shaking until the catalyst covered the aluminum metal. The mixture was continuously heated for 2-3 hours by keeping the container on the hotplate at 200° C., however the mixture may be heated for between 0-240 hours (0-10 days).

Over the course of the heat treatment, the mixture was agitated 3-4 times manually. Alternatively, the mixture may be continuously agitated, for example by a rotating drum. The rotating drum may have integrated heaters either internal or external to the drum, as shown in FIG. 2 for example.

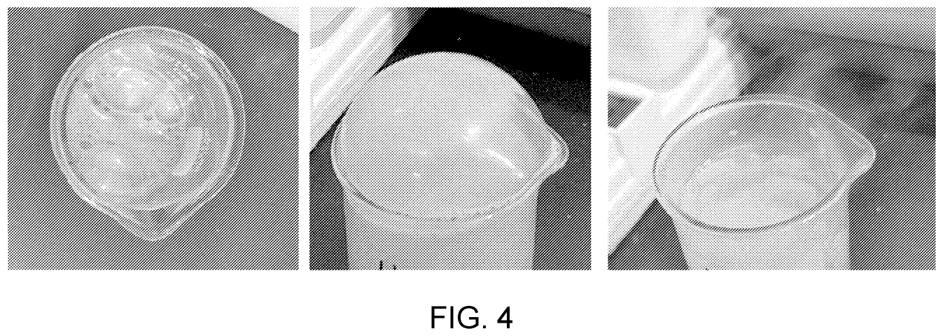

Water was added to the catalyst-activated aluminum, and bubbles began to form on the surface of the aluminum due to the decomposition of water into hydrogen gas as shown in FIG. 3. As the reaction proceeded, a greater amount of aluminum surface area was exposed, and the temperature increased. After a few minutes, the reaction rate exponentially increased, causing the water to boil due to the rate of heat release in the reaction, as shown in FIG. 4. The reaction process may also take place in a different container than shown in FIG. 3 and FIG. 4, including an aluminum-water reactor.

Because Sample D melts at ~60° C., which is above room temperature, it may be beneficial to the initial reaction kinetics to mix aluminum fuel containing this catalyst with aluminum fuel containing another catalyst composition, such as one with a melting point below room temperature.

Alternatively, or in addition, it may be beneficial to preheat the incoming water source for the aluminum-water reaction to aid in the reaction kinetics when using this catalyst composition.

Samples A, B, C, and E may be prepared and used to activate aluminum using methods substantially the same as those described above.

Preparation of Activated Aluminum from Used Beverage Cans Using Sample C (33% Catalyst by Mass) and Reaction with Water

Scrap aluminum sourced from shredded used beverage cans (UBCs) (2.240 g) was activated with Sample C (1.111 g) and reacted with water using similar procedures as described above for Sample D. The amount of catalyst constituted about 33% by mass of the final water-reactive aluminum composition, and water was heated to 60° C. before being reacted with the activated aluminum.

The yield of this reaction was 77%, expressed as reaction efficiency (% energy released as heat and hydrogen of the theoretical energy embedded in the aluminum). The following power output was observed:
Average Power (W): 170.5
Peak Power (W): 1257
Average Specific Power (kW/kg): 76.13
Peak Specific Power (kW/kg): 561.4

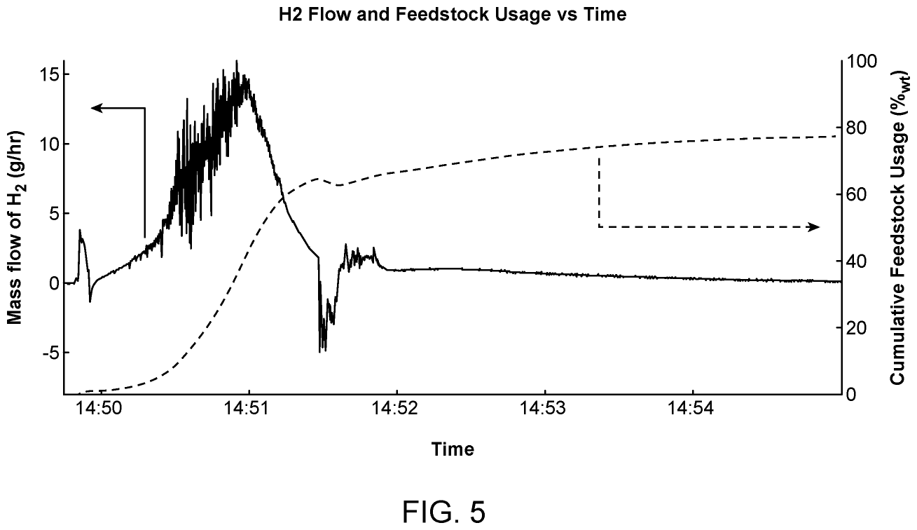

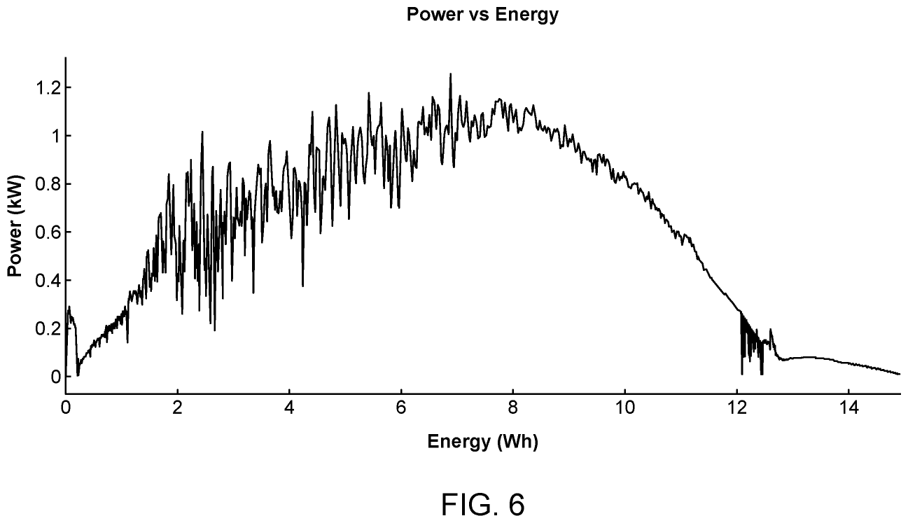

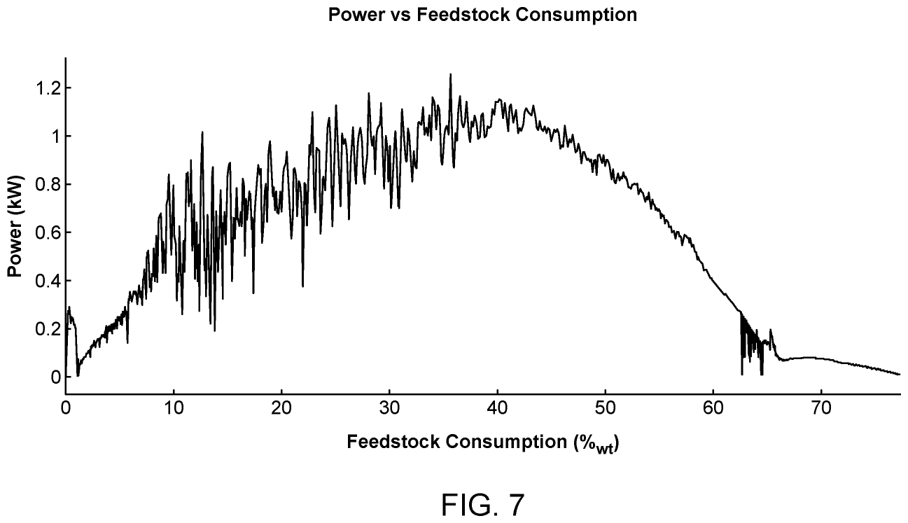

FIG. 5 shows the hydrogen flow and activated aluminum consumption over time during the reaction. FIG. 6 shows the power as a function of energy resulting from the reaction. FIG. 7 shows the power as a function of activated aluminum consumption resulting from the reaction.

Preparation of Activated Aluminum from Used Beverage Cans Using Sample C (50% Catalyst by Mass) and Reaction with Water

Scrap aluminum sourced from shredded used beverage cans (UBCs) (0.742 g) was activated with Sample C (0.739 g) and reacted with water using similar procedures as described above for Sample D. The amount of catalyst constituted about 50% by mass of the final water-reactive aluminum composition, and water was heated to 60° C. before being reacted with the activated aluminum.

The yield of this reaction was 98%, expressed as reaction efficiency (% energy released as heat and hydrogen of the theoretical energy embedded in the aluminum). The following power output was observed:
Average Power (W): 208.2
Peak Power (W): 957.3
Average Specific Power (kW/kg): 281.7
Peak Specific Power (kW/kg): 1295

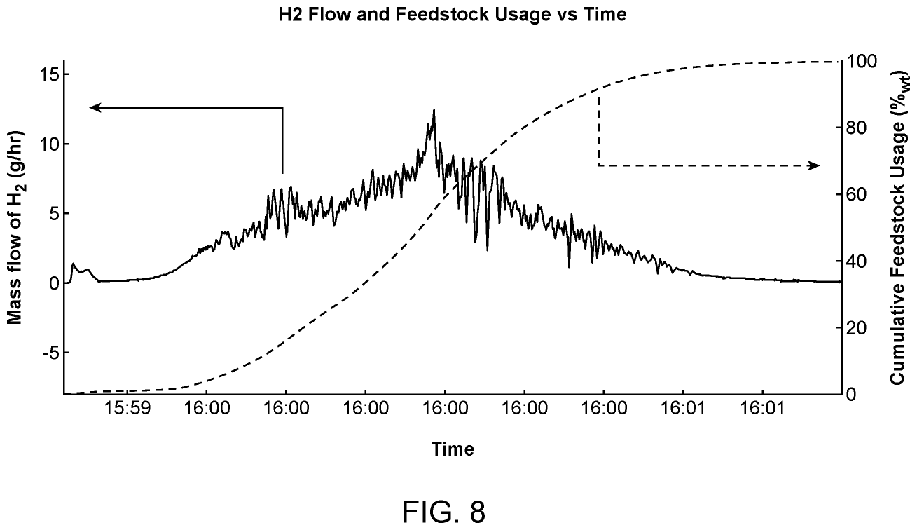

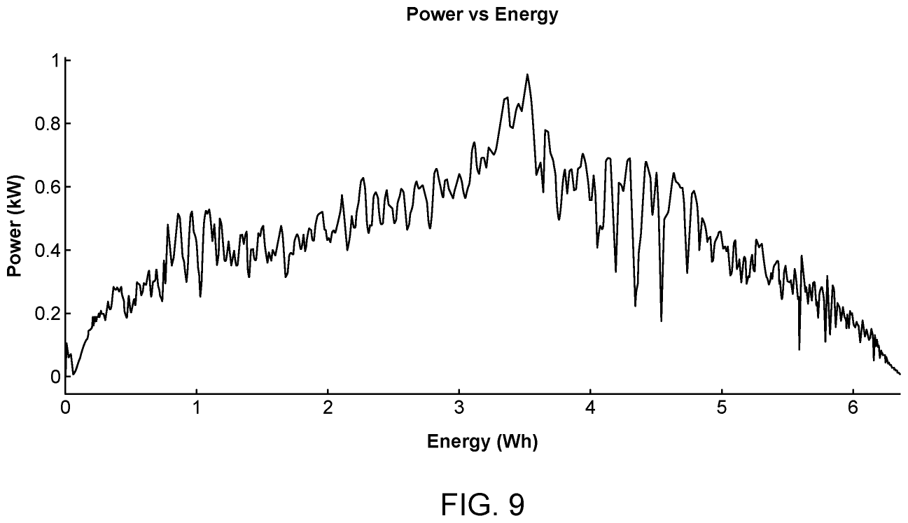

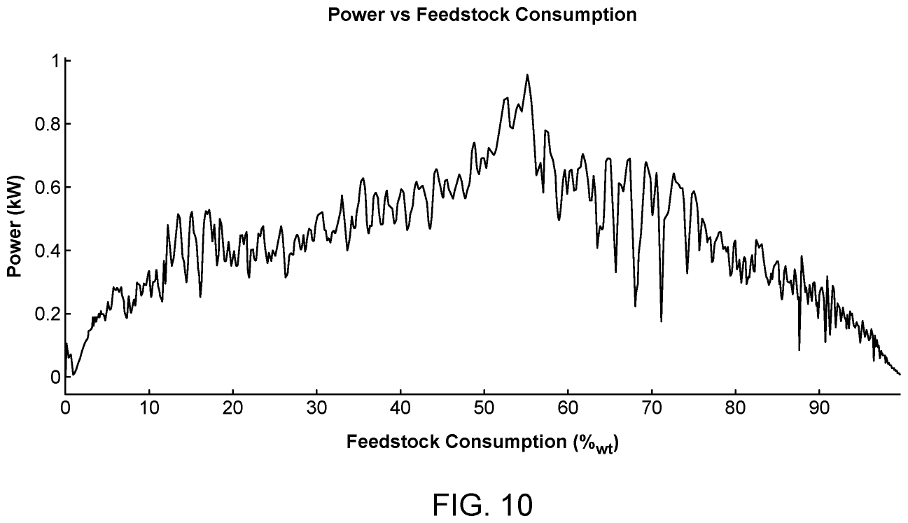

FIG. 8 shows the hydrogen flow and activated aluminum consumption over time during the reaction. FIG. 9 shows the power as a function of energy resulting from the reaction. FIG. 10 shows the power as a function of activated aluminum consumption resulting from the reaction.

Preparation of Activated Aluminum from Used Beverage Cans Using Sample C (50% Catalyst by Mass) and Reaction with Water

Scrap aluminum sourced from shredded used beverage cans (UBCs) was activated with Sample C and reacted with water using similar procedures as described above for Sample D. The amount of catalyst constituted about 50% by mass of the final water-reactive aluminum composition, and water was heated to 60° C. before being reacted with the activated aluminum.

The yield of this reaction was 94%, expressed as reaction efficiency (% energy released as heat and hydrogen of the theoretical energy embedded in the aluminum), and 84% of the initial activating metal alloy catalyst was recovered in its starting state following completion of the reaction. The following power output was observed:
Average Power (W): 278.6
Peak Power (W): 1288
Average Specific Power (kW/kg): 169.6
Peak Specific Power (kW/kg): 783.8

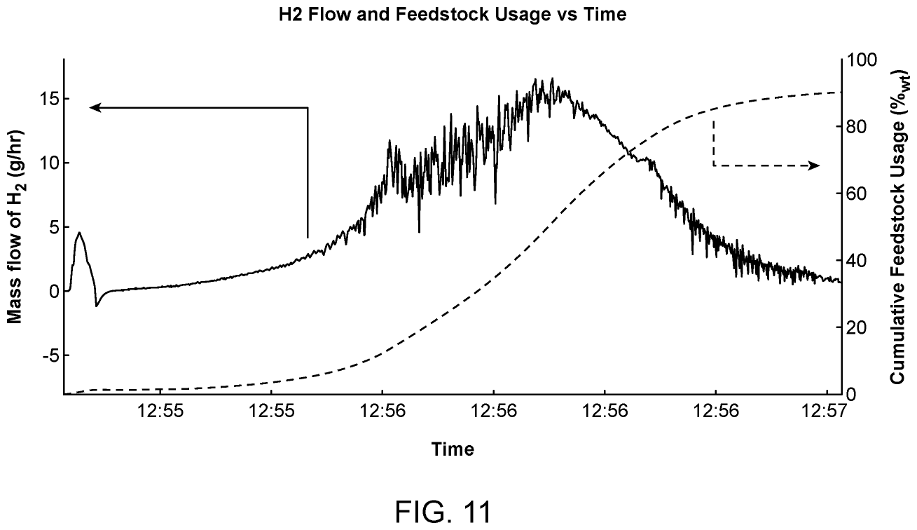

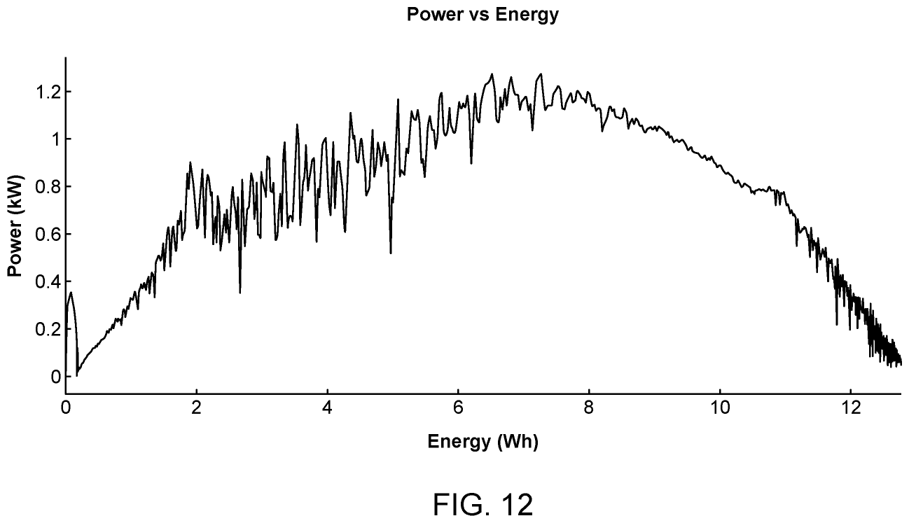

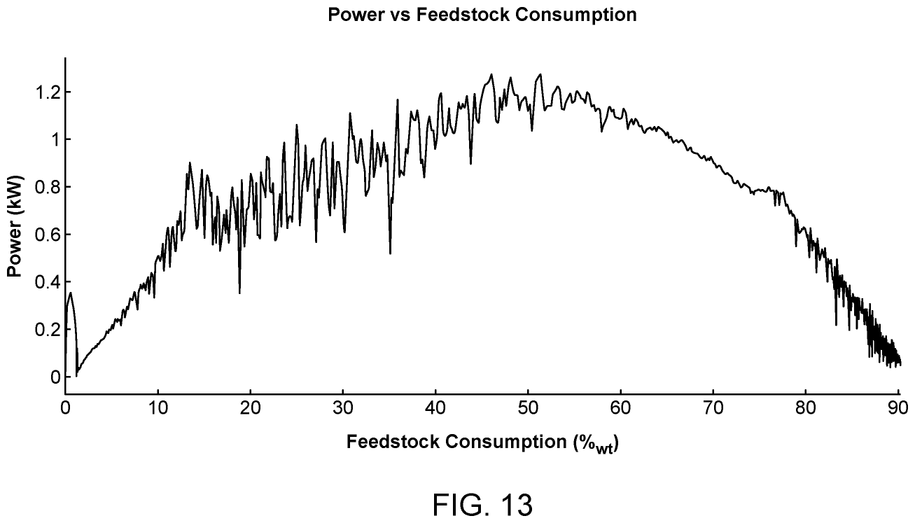

FIG. 11 shows the hydrogen flow and activated aluminum consumption overtime during the reaction. FIG. 12 shows the power as a function of energy resulting from the reaction. FIG. 13 shows the power as a function of activated aluminum consumption resulting from the reaction.

Preparation of Activated Aluminum Using Sample F and Reaction with Water

To activate aluminum with Sample F, the catalyst was heated even though the catalyst has a melting point below room temperature. For example, a hotplate set to 200° C. was used to pre-heat the catalyst; however, another form of heating may also be used. The aluminum was preheated in an oven at 130° C. The catalyst and aluminum were placed in a sealed container, achieving a catalyst weight percentage of 5% of the total fuel. Aluminum may also be activated by other ratios of catalyst mass from 0 to about 3%, from 3 to about 6%, from about 6 to about 10%, from about 10 to about 100%, and from about 100 to about 700% of the aluminum mass being activated. The container was agitated by shaking until the catalyst covered the aluminum metal. The mixture was continuously mixed and heated for 1-2 hours by keeping the container in a rotating oven (see, e.g., FIG. 2) at 130° C., however the mixture may be heated for between 0-240 hours (0-10 days) over a range of temperatures from room temperature to 130° C. The mixture may also be activated manually, agitating 3-4 times over the course of heating the container.

When water was added to the catalyst-activated aluminum, the reaction kinetics proceeded similarly to the results described in Sample D. A typical reaction resulted in a reaction yield of 86-92%, expressed as reaction efficiency (% energy released as heat and hydrogen of the theoretical energy embedded in the aluminum). Ninety percent of the initial catalyst was recovered in its starting state following the reaction. In another example, shredded used beverage cans (UBC) were activated in a rotating oven with Sample F and a catalyst weight percent approaching 20% of the activated aluminum. The reaction yield of this sample was 64%, expressed as reaction efficiency (% energy released as heat and hydrogen of the theoretical energy embedded in the aluminum).

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. Provide herein are embodiments in which exactly one member of the group is present in, employed in, or otherwise relevant to a given product or process. Provided herein are embodiments in which more than one, or all of the group members are present in, employed in, or otherwise relevant to a given product or process.

Furthermore, the inventions provided herein encompass all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should be understood that, in general, where the inventions provided and described herein, or aspects of the inventions described and provided herein, is/are referred to as comprising particular elements and/or features, certain embodiments of the inventions or aspects of the inventions consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the inventions described and provided herein, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment that falls within the prior art may be explicitly excluded from any one or more of the claims. Because such embodiments are deemed to be known to one of ordinary skill in the art, they may be excluded even if the exclusion is not set forth explicitly herein. Any particular embodiment can be excluded from any claim, for any reason, whether or not related to the existence of prior art.

Each numerical value presented herein is contemplated to represent a minimum value or a maximum value in a range for a corresponding parameter. Accordingly, when added to the claims, the numerical value provides express support for claiming the range, which may lie above or below the numerical value, in accordance with the teachings herein. Every value between the minimum value and the maximum value within each numerical range presented herein (including any minimum, nominal, and maximum values shown in any tables), is contemplated and expressly supported herein, subject to the number of significant digits expressed in each particular range. The application expressly contemplates the ranges between the minimum and nominal values, nominal and maximum values, and minimum and maximum values.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present inventions, as defined in the following claims.

What is claimed:

1. A water-reactive aluminum composition comprising:
aluminum or an alloy thereof having a surface oxide layer, an interior volume, and a microstructure; and
a non-eutectic activating metal alloy comprising bismuth, tin, indium, and gallium, wherein the non-eutectic activating metal alloy is disposed along the microstructure of the aluminum or the alloy thereof and wherein the non-eutectic activating metal alloy is less than or equal to about 10% gallium by mass, and
wherein when water is introduced to the composition, the aluminum or alloy thereof disintegrates to expose the interior volume to the water, and a rapid hydrolysis reaction occurs.

2. A water-reactive aluminum composition comprising:
aluminum or an alloy thereof having a surface oxide layer, an interior volume, and a microstructure; and
an activating metal alloy comprising at least two metals selected from the group consisting of bismuth, tin, and indium, wherein the activating metal alloy is disposed along the microstructure of the aluminum or the alloy thereof,
wherein when water is introduced to the composition, the aluminum or alloy thereof disintegrates to expose the interior volume to the water, and a rapid hydrolysis reaction occurs,
wherein the water-reactive aluminum composition contains no gallium.

3. The water-reactive aluminum composition of claim 2, wherein the activating metal alloy comprises bismuth, tin, and indium.

4. The water-reactive aluminum composition of claim 1, wherein the activating metal alloy consists essentially of bismuth, gallium, indium, and tin.

5. The water-reactive aluminum composition of any one of claims 1-4, wherein the water-reactive aluminum composition is formed by a process comprising contacting the aluminum or alloy thereof with the activating metal alloy, wherein the activating metal alloy is in liquid form and the aluminum or alloy thereof is in solid form at the time the aluminum or alloy thereof is contacted with the activating metal alloy.

6. The water-reactive aluminum composition of claim 5, wherein the activating metal alloy is heated at or above its melting point prior to contacting the aluminum or alloy thereof.

7. The water-reactive aluminum composition of any one of claims 1-6, wherein the activating metal alloy has a melting point below the melting temperature of the aluminum or alloy thereof.

8. The water-reactive aluminum composition of any one of claims 1-7, wherein the activating metal alloy has a melting point of less than 200° C.

9. The water-reactive aluminum composition of any one of claims 1-8, wherein the activating metal alloy has a melting point of less than 100° C.

10. The water-reactive aluminum composition of any one of claims 1-9, wherein the activating metal alloy is at least about 6% or about 6% of the total mass of the water-reactive aluminum composition.

11. The water-reactive aluminum composition of any one of claims 1-10, wherein the aluminum or alloy thereof comprises one or more alloying elements selected from the group consisting of copper, silicon, iron, manganese, zinc, titanium, magnesium, lithium, cadmium, zirconium, beryllium, scandium, sodium, cerium, yttrium, silver, calcium, boron, chromium, bismuth, lead, vanadium, nickel, cobalt, oxygen, and gallium, the alloying elements having in total from 0 to about 20% of the total mass of the aluminum.

12. The water-reactive aluminum composition of any one of claims 1-10, wherein the activating metal alloy comprises Field's Metal, comprising about 51.2% indium; about 32.0% bismuth; and about 16.8% tin by mass.

13. The water-reactive aluminum composition of any one of claims 1-12, wherein the activating metal alloy comprises less than about 10% gallium by mass.

14. The water-reactive aluminum composition of any one of claims 1-13, wherein the activating metal alloy is solid at room temperature (e.g., at 20° C.).

15. The water-reactive aluminum composition of any one of claims 1-14, wherein the activating metal alloy is liquid below the melting point of indium (about 157° C.).

16. A method of activating aluminum or an alloy thereof, the method comprising:
contacting the aluminum or alloy thereof with a non-eutectic activating metal alloy comprising bismuth, tin, indium, and gallium to provide a mixture; and
heating the mixture above the melting temperature of the non-eutectic activating metal alloy and below the melting temperature of the aluminum or alloy thereof for a predetermined period of time to provide a water-reactive aluminum composition.

17. A method of activating aluminum or an alloy thereof, the method comprising:
contacting the aluminum or alloy thereof with an activating metal alloy comprising tin, indium, and gallium to provide a mixture; and
heating the mixture above the melting temperature of the non-eutectic activating metal alloy and below the melting temperature of the aluminum or alloy thereof for a predetermined period of time to provide a water-reactive aluminum composition.

18. The method of claim 17, wherein the non-eutectic activating metal alloy does not comprise bismuth.

19. A method of activating aluminum or an alloy thereof, the method comprising:
contacting the aluminum or alloy thereof with an activating metal alloy comprising at least two metals selected from the group consisting of bismuth, tin, and indium to provide a mixture, wherein the mixture contains no gallium; and
heating the mixture above the melting temperature of the activating metal alloy for a predetermined period of time to provide a water-reactive aluminum composition.

20. The method of claim 19, wherein the activating metal alloy comprises bismuth, tin, and indium.

21. The method of any one of claims 16-20, wherein contacting the aluminum or alloy thereof with the activating metal alloy comprises melting the activating metal alloy and applying the activating metal alloy evenly to the surface of the aluminum or alloy thereof.

22. The method of any one of claims 16-21, wherein the mixture comprises the activating metal alloy in an amount of about 30% of the mass of the aluminum or alloy thereof.

23. The method of any one of claims 16-22, wherein the predetermined period of time is about 2 hours to about 3 hours.

24. The method of any one of claims 16-18 and 21-23, further comprising varying the amount of gallium in the activating metal alloy such that the temperature required for the water-reactive aluminum composition to react with water is altered.

25. The method of any one of claims 16-18 and 21-23, further comprising varying the amount of gallium in the activating metal alloy such that the temperature at which the rate of reaction of the water-reactive aluminum composition with water accelerates to form steam upon contact of the water-reactive aluminum composition with water is altered.

26. The method of any one of claims 16-18 and 21-23, further comprising varying the amount of gallium in the activating metal alloy such that hydrogen gas is produced in the absence of steam upon contact of the water-reactive aluminum composition with water.

27. The method of any one of claims 16-26, further comprising continuously agitating the mixture of the aluminum or alloy thereof and activating metal alloy in a rotating drum while heating the mixture above the melting point of the activating metal alloy.

28. The method of claim 27, wherein the mixture is heated with a heating element that is internal to the rotating drum.

29. The method of claim 27, wherein the mixture is heated with a heating element that is external to the rotating drum.

30. A method of providing hydrogen and/or steam, the method comprising contacting a water-reactive aluminum composition of any one of claims 1-15 with water, wherein a rapid hydrolysis reaction occurs, thereby providing hydrogen and/or steam.

31. The method of claim 30, further comprising recovering at least about 95% of the activating metal alloy after the rapid hydrolysis reaction occurs.

32. A fuel mixture comprising a plurality of water-reactive aluminum compositions of any one of claims 1-15 and a plurality of water-reactive aluminum compositions comprising aluminum and from 0 to about 3% or from about 3 to about 6% gallium by mass, wherein gallium is present in varying amounts in the plurality of compositions, and wherein the varying amounts of gallium achieves a distribution of reaction rates at a given reaction initiation temperature or steady-state operating temperature when the compositions are contacted with water.
